(19) United States
(12) Patent Application Publication
(10) Pub. No.: US 2016/0034235 A1
(43) Pub. Date: Feb. 4, 2016

(54) NETWORK PRINTER

(71) Applicants: KABUSHIKI KAISHA TOSHIBA, Tokyo (JP); TOSHIBA TEC KABUSHIKI KAISHA, Tokyo (JP)

(72) Inventor: TAKAHIRO OGISU, Mishima Shizuoka (JP)

(21) Appl. No.: 14/449,064

(22) Filed: Jul. 31, 2014

(51) Int. Cl. G06F 3/12

(52) U.S. Cl. CPC G06F 3/1263; G06F 3/1212; G06F 3/1253

(57) ABSTRACT

A network printer is connected to a plurality of information terminals over a network. The execution order of printing jobs received by the network printer over the network is specified based on printing job information included in the printing jobs received from the information terminals, and based on login information of a user who is logging into the network printer to execute the printing job on the network printer.

### BACKGROUND

In recent years, with a widespread use of a network, a so-called network printer printing via the network has become widely used. Under an environment of printing via the network, a plurality of users share and use a printer in many cases. When a specific user executes a large printing job in a shared printer, and a second user wants to execute a printing job using the shared printer, the second user needs to wait for a long time until printing is finished. Moreover, when sending a printing job to the shared printer via a network, there are many cases where the printer is not in the vicinity of a user. Therefore, the user may go several times to an installation, location of the printer that is far away for confirmation that the printing is finished.

For this reason, a technology for managing printing requests from a plurality of users has been developed where a printing order of a plurality of printing jobs.

However, particularly under a security-aware use environment, a network printing job may not cause a paper to be discharged as it is. Instead, a job type like a hold job, which does not start printing until a user goes to an installation location of a printer and performs an output operation by logging in the printer, is used in many cases. However, both a printing job of one user required to be immediately output and a printing job of a second user required to be output after awhile, are processed in a received order with the same priority.

Therefore, even though the first user logs into the printer for outputting the printing job required to be immediately printed, the user may need to wait until the user's job is processed according to the received order.

### DESCRIPTION OF THE DRAWINGS

FIG. 1 is a schematic diagram illustrating an embodiment of a network printer connected over a network to plurality of information terminals.

FIG. 2 is a diagram schematically illustrating an example of RIP execution performed by the network printer.

FIG. 3 is a conceptual diagram illustrating the grant of execution priority.

FIG. 4A is a diagram illustrating an RIP execution order and associated users and domains.

FIG. 4B is a diagram illustrating a change in the RIP execution order in response to a user login.

FIG. 5 is a conceptual diagram illustrating the grant of execution priority.

FIG. 6A is a diagram illustrating an execution order and associated priorities.

FIG. 6B is a diagram illustrating a change in the execution order in response to adding another printing job with a high priority.

FIG. 7 is a diagram illustrating an operation screen display example for selecting a printing job priority.

FIG. 8 is a diagram illustrating an operation screen display example for selecting a printing job priority.

### DETAILED DESCRIPTION

Embodiments provide a network printer which may shorten a waiting time for printing while maintaining confidentiality.

In general, according to one embodiment, there is provided a network printer connected to a plurality of information terminals over a network. The execution order of printing jobs received by the network printer over the network is specified based on printing job information included in the printing jobs received from the information terminals, and based on login information of a user who is logging into the network printer to execute the printing job on the network printer.

Hereinafter, an embodiment will foe described in detail with reference to the drawings.

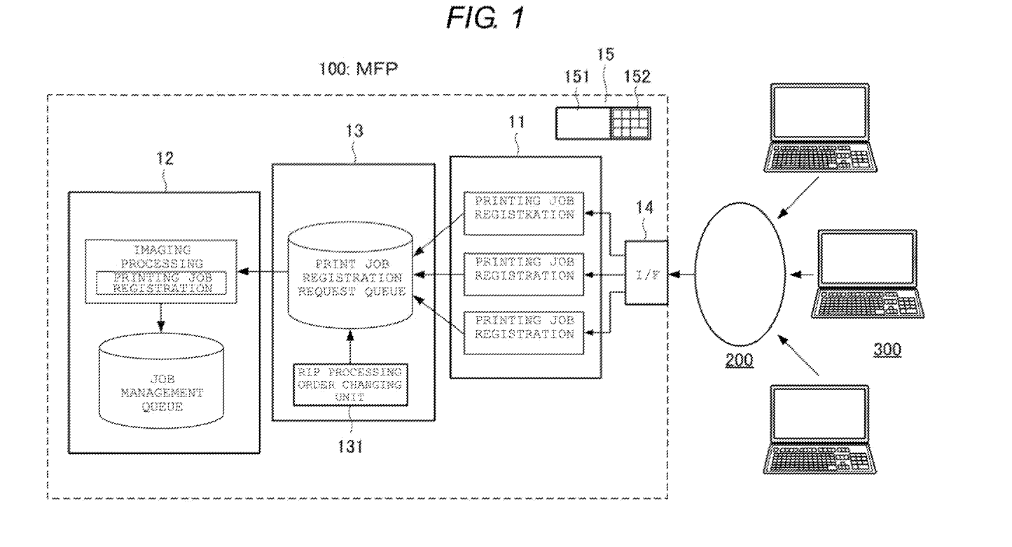

FIG. 1 is a schematic diagram illustrating an embodiment of a network printer connected over a network to plurality of information terminals.

A network printer illustrated in FIG. 1 is configured from, for example, a Multi Function Peripheral (MFP) 100, which is connected to a network 200, and a plurality of personal computers (PCs) 300 which are network information terminals. The MFP 100 is an all-in-one type multifunction printer which includes a plurality of functions such as copying, scanning, faxing, and the like in addition to a function of printing.

The MFP 100 includes a network layer 11 having a plurality of receiving ports, and an RIP processing execution unit 12 which may execute Raster Image Processor (RIP) processing for one job so as to perform a network printing job. The network layer 11 and the RIP processing execution unit 12 are connected to each other under the control of an RIP execution request management unit 13.

Here, the RIP is image conversion processing which generates image data for printing by analyzing and developing the printing data received through a network interface 14. A printing job is a task to print an image on a sheet by performing the RIP processing on the printing data received from the network PC 300 and driving a printer engine which is not illustrated based on the generated image data. The printing job may be a task to print an image on a sheet based on an instruction from an operation unit 152 of a control panel 15 with the image held in a hard disk without instantly printing the image out. The RIP processing may use various known methods.

In MFP 100 illustrated in FIG. 1, only configurations of the network layer 11, the RIP processing execution unit 12, the RIP execution request management unit 13 are illustrated. Specific configurations of copier, scanner, fax, and the like are omitted.

In the embodiment, in order to allow a change in the execution order of the network printing job in accordance with wishes of a user, the RIP execution request management unit 13 includes an RIP processing order changing unit 131 which changes an order of the RIP processing. Validity or invalidity of this function may be set by an administrator. The RIP processing order changing unit 131 may change the order of the RIP processing by an operation from the network PC 300 or the control panel 15.

The network layer 11 includes a spool function which store printing data sent through the network 200 until the RIP processing is completed. In the network layer 11, an execution request from the network 200 is performed in parallel for each protocol and port. User information or printing job information which is not related to an image such as a document name, priority, and the like may be analyzed in advance by a Printer Job Language (PJL) given by a printer driver and be given to an execution request of the RIP.

Information on, for example, a document name, a user name, a domain name, a job type, a private password, and a priority is passed onto the RIP execution request management unit 13 for processing an execution request of the RIP. The execution request of the RIP is generated when a data transfer from the network layer 11 begins. In the RIP execution request management unit 13, printing job ID issuance processing, and associating a reception ID with a printing job ID are executed.

The RIP processing execution unit 12 executes actual imaging processing on printing data received from the network PC 300.

The RIP execution request management unit 13 queues the execution requests of the RIP, and then performs a control to sequentially process printing requests as soon as the RIP of the RIP processing execution unit 12 is vacant.

In addition, the RIP execution request management unit 13 includes a function of switching an order waiting for an execution request of the RIP in addition to the control to sequentially process printing requests. This is an RIP processing order changing unit 131.

The RIP processing order changing unit 131 performs processing of automatically switching an execution order of the RIP processing in the MFP 100 with reference to printing job information or login information. As a result, a particular printing lob may be quickly executed.

As described above, when a plurality of users continuously perform printing, and there is printing required to be output in hurry, the printing is performed with an output order changed. When the user directly logs in from the control panel 15 of the MFP 100, it is possible to determine that a user who instructs printing is present at an installation location of the MFP 100, and to perform the printing of the user in a preferential manner.

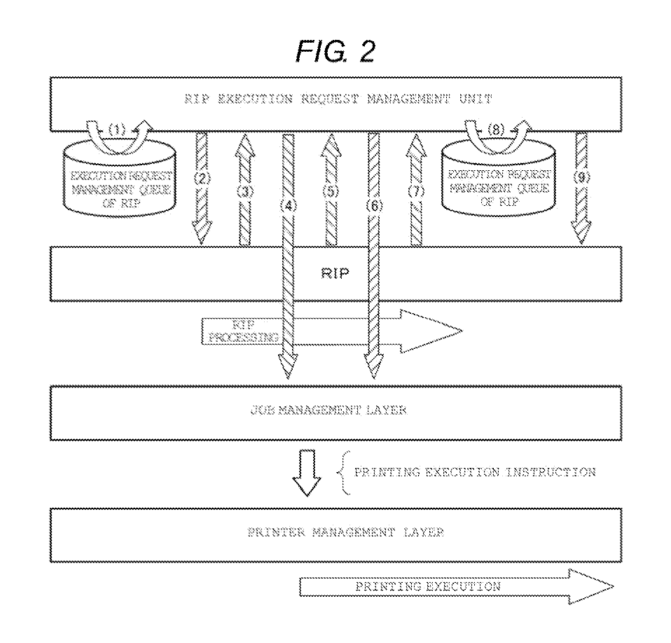

FIG. 2 schematically illustrates an example of RIP execution performed by the RIP execution request management unit 13. When registering a network printing job from the network layer 11, the network printing job is registered in a queue and waits for a vacancy of RIP resources (processing unit) if there is no vacancy of the RIP resources in the RIP execution request management unit 13.

First, the RIP execution request management unit 13 pops an execution request of the RIP from the queue in (1) of FIG. 2. Next, in (2), an execution instruction of the RIP is applied to the RIP processing execution unit 12. In (3), a registration instruction of a printing job is applied from the RIP which analyzes information on the printing job. In (4), the job registration instruction is transmitted to a job management layer. The job management layer applies a printing instruction to a printer management layer as it is and printing begins once there is a printing job of one page. In (5), an analysis completion event of ail pages is notified from the RIP. In (6), an event of confirmation on the number of pages is transmitted to the job management layer. In (7), a processing completion of the printing job is notified from the RIP.

Then, in (8), an execution request of a next printing job is popped out from the queue. That is, the same processing as (1) is executed for a next user's printing job. After (9), the same processing as from (2) to (7) is executed until there is no registered printing job.

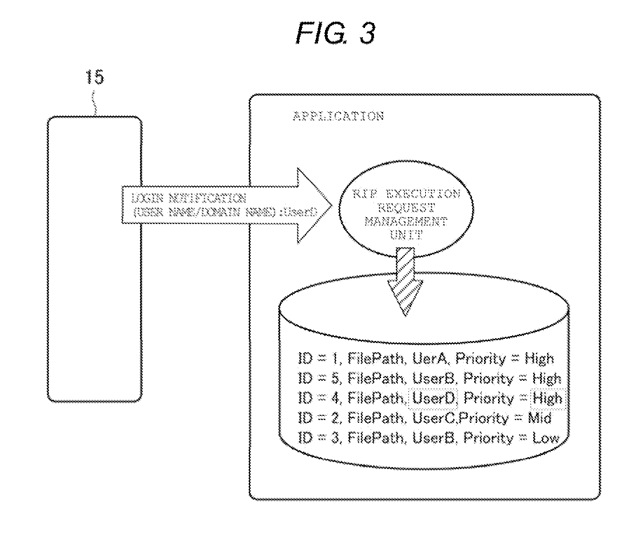

Next, processing of changing the RIP execution order caused by a request from the control panel 15 will be described with reference to FIG. 3.

If there is an execution request queue and an execution request is popped out from the execution request queue, a driving command is applied to the RIP. The RIP displays a job status on a display unit 151 of the control panel 15 when the RIP recognizes information necessary for a job registration. Information necessary for printing in addition to a document name, a user name, a color mode, and the like is displayed on the display unit 151. By displaying a job registration instruction, a series of processing is completed.

When the RIP corresponding to one document finishes, Information in which a last page is confirmed is sent. When the information in which a last page is confirmed is received, processing on a printing job of an object becomes the end by confirming the number of pages.

Then, processing is repeated by popping a next execution request and repeating the RIP processing in the same order until there is no printing job.

If the RIP resources are not vacant when registering a network printing job, the RIP execution request management unit 13 registers the RIP resources and waits for a vacancy of the RIP resources. When registering this queue, the RIP execution request management unit 13 first acquires information on a network printing job for specifying an execution user such as a user name, a domain name, and the like in a printing job. The RIP execution request management unit manages the information on a network printing job as a part of an execution request of the RIP, so that a job of a login user may be specified when a user logs in.

Information on a printing job which is not related to printing such as user information and the like is given as attribute information from a printer driver. The information is acquired to be analyzed, and given to an execution request when registering a queue.

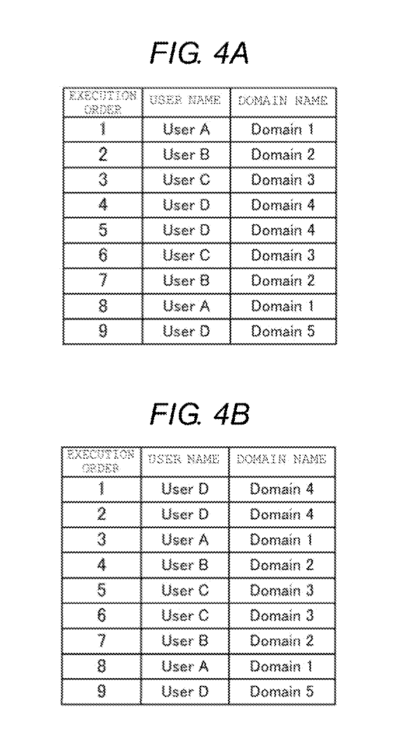

As illustrated in FIG. 4A, printing jobs are registered in the RIP execution request management queue in a received order, and thereby the jobs are executed in a registered order of a queue as soon as the RIP resources become vacant.

By moving a job matching up with a login user information as illustrated in FIG. 4B to the head of the RIP execution request management queue when a user logs in, a job of the login user is executed as soon as RIP resources become vacant.

FIG. 4B illustrates an example in which a user logs in using a user name “user D”, and a domain name “Domain 4” with respect to the execution order of FIG. 4A. By this login, two jobs of User D and Domain 4 are switched to a first order and a second order in an execution order. Accordingly, an execution order of a printing job is changed from a fourth and a fifth order to a first and a second order.

Moreover, when another login is made by a separate user after the switch of a processing order by login as described above, a control of printing a printing job of a login user in a preferential manner may be maintained by registering a printing job of a user who logs in later prior to a printing job of a user who logs in earlier.

Moreover, login information to the MFP 100 main body is input from the control panel 15 when input by manual, but when using a card in which login information is stored, the login information may be acquired by putting the card over a card reader which is not illustrated.

Next, a case of switching the processing order by a setting set when registering a network printing job will be described.

When a user registers a network printing job, an application such as a printer driver is considered to be used. In this application, an option which may execute printing in a preferential manner is provided, thereby enabling a user to specify a priority.

The RIP execution request management unit 13 analyzes a priority in a network printing job which is specified by a user and manages the priority as a part of execution request information of the RIP. Then, when registering a network printing job in the RIP execution request management queue, the network printing job is registered at the rear end of an execution request having the same priority, and thus it is possible to execute RIP processing in a preferential manner when a user is in a hurry.

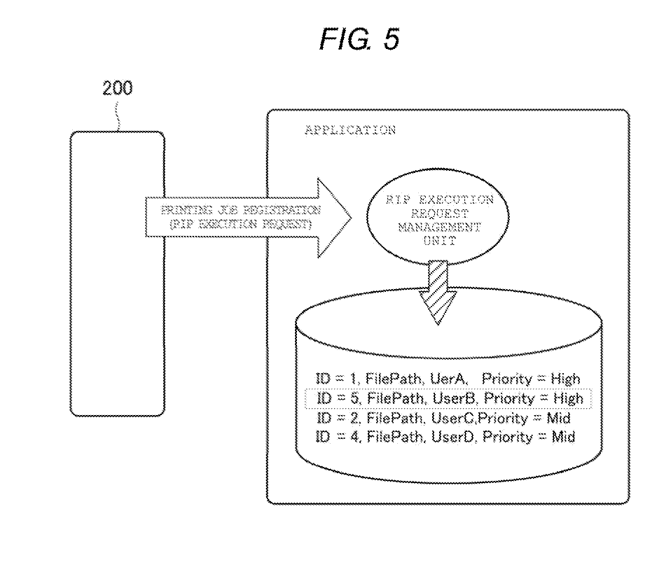

Processing of changing an RIP execution order when using priority information from the network PC 300 will be described with reference to FIG. 5.

As for priority, for example, a menu to specify a priority is added in the printer driver. That is, a priority such as “@PJL COMMENT DSSC PRINT PRIORITY=HIGH” is newly provided in PJL information given by the printer driver. This priority information is given when requiring an RIP execution as illustrated in FIG. 5. Accordingly, it is possible to have this priority information as priority information when registering a printing job.

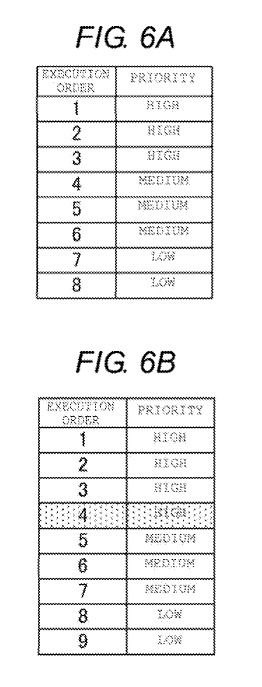

As illustrated in FIG. 6A, by applying the priority information when registering a printing job, the printing job is executed, for example, in a descending order of priority. In FIG. 6B, when a printing job with a “high” priority newly occurs in an execution order illustrated in FIG. 6A, it is illustrated that the job is set as a fourth execution order after three jobs with “high” priority to execute the printing job. The priority herein is indicated by three types such as high, medium, and low.

Accordingly, it is possible to execute a preferential printing job considering a complaint from a user in a descending order of priority.

As a method of changing a priority, printing jobs of the same user name may be brought to the head. In addition, considering a priority of jobs, all may be set to a high priority and brought to the head.

The priority of the printer driver may be set as a default, but other user may be considered by not allowing a priority to be set in the default.

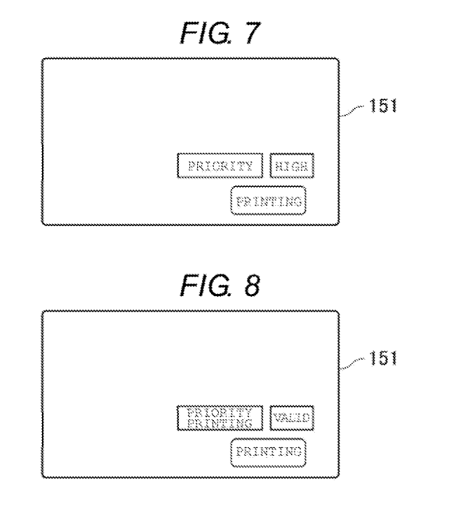

FIGS. 7 and 8 illustrate an operation screen display example of a printer driver of a network PC 300 for executing a printing job in a preferential manner.

That is, “priority” is selected from each menu on a job registration screen of the printer driver shown in FIG. 7. “High” is selected from “high, medium, low” of a menu of priority. Then, a selection is made from a menu called priority.

FIG. 8 illustrates another example of a display which shows settings of priority printing. In this example, the user may choose “VALID” or “INVALID” based on whether the printing is performed with priority or not.

In the embodiment, a waiting time for a user to wait until a network printing job may be executed may be minimized. In addition, when executing network printing, it is possible to ensure confidentiality by printing based on login information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A network printer to which a plurality of information terminals are connected over a network, the network printer comprising:
a network interface configured to receive printing jobs from the plurality of information terminals through the network;
a processor configured to generate image data for printing from each of the received printing jobs in sequence according to an execution order;
a management unit configured to manage a queue defining the execution order, the execution order being initially set based on printing job information included in the printing jobs;
an operation unit configured to receive login data of a user associated with at least one of the received printing jobs; and
a printer configured to print the generated image data corresponding to the printing job associated with the user after the operation unit receives the login data but not before the operation unit receives the login data, wherein
if the login data is received before the image data from the corresponding printing job has been generated, the queue management unit changes the execution order so that the corresponding printing job is moved higher in the execution order.

2. (canceled)

3. The network printer according to claim 1, wherein the RIP execution request management unit is configured to analyze a priority information included in a new printing job received over the network, and insert the new printing job into the queue such that the execution order of the new printing job is after a group of printing jobs in the queue that have the same priority.

4. The network printer according to claim 1, wherein the login information is at least one of a user name and a domain name.

5. The network printer according to claim 1, wherein the printing jobs associated with the same login information of the user are all executed sequentially.

6. The network printer according to claim 1, wherein
the printing job information includes priority information that defines a priority of printing jobs and the execution order is specified based on the priority information.

7. The network printer according to claim 1, wherein when login information is stored in a card, and the login is performed using the card.

8. The network printer according to claim 1, wherein
the operation unit is configured to receive input for changing the execution order of the printing jobs.

9.-10. (canceled)

11. The network printer according to claim 1, wherein the printing job corresponding to the received login data is moved to the top of the execution order.

12-15. (canceled)

16. A method of executing printing jobs with a network printer, comprising:
receiving printing jobs at the network printer from a plurality of information terminals over a network;
performing processing on the printing jobs to generate image data for printing each of the received printing jobs, in sequence according to an execution order;
managing a queue defining the execution order, the execution order being initially set based on printing job information included in the printing jobs;
receiving login data from a user associated with at least one of the received printing jobs; and
printing the generated image data corresponding to the printing job associated with the user receiving the login data but not before receiving the login data, wherein
if the login data is received before the image data from the corresponding printing job has been generated, the execution order is changed as necessary so that the corresponding printing job is moved higher in the execution order.

17. The method according to claim 16, wherein the printing job corresponding to the received login data is moved to the top of the execution order.

18. (canceled)

19. The method according to claim 16, wherein the execution order of the printing jobs is initially set based on priority information included in the printing jobs.

20. The method according to claim 19, further comprising: receiving an input for changing the priority information included in a printing job through a control panel of the network printer.

21. The method according to claim 16, further comprising:
analyzing a priority information included in a new printing job received over the network, and
inserting the new printing job into the queue such that the execution order of the new printing job is at a rear end of a group of printing jobs in the queue that have the same priority.

22. The method according to claim 16, wherein
the login information is at least one of a user and a domain name.

23. The method according to claim 16, wherein the printing jobs associated with the same login information of the user are all executed sequentially.

24. The method according to claim 16, wherein when login information is stored in a card, and the login is performed using the card.
